(19) United States
(12) Patent Application Publication
(10) Pub. No.: US 2008/0195906 A1
(43) Pub. Date: Aug. 14, 2008

(54) TEST PATTERN GENERATION APPARATUS AND TEST PATTERN GENERATION METHOD

(76) Inventors: Miho OTAKA, Yokohama (JP); Hirofumi Shinke, Yokohama (JP); Shinichi Akiba, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/867,157

(22) Filed: Oct. 4, 2007

(30) Foreign Application Priority Data
Feb. 13, 2007 (JP) 2007-032272

(51) Int. Cl. G06F 11/00

(52) U.S. Cl. 714/738; 714/E11.001

(57) ABSTRACT

A test pattern generation apparatus extracts processing that coincides with input combinational test confirmation processing from program test patterns stored in a file, extracts execution conditions of the extracted processing from program test pattern lists, rearranges the execution conditions, generates one test pattern, extracts data handling processing that satisfies conditions in the test pattern lists, and generates and displays a combinational test pattern list.

### INCORPORATION BY REFERENCE

The present application claims priority from Japanese application JP2007-032272 filed on Feb. 13, 2007, the content of which is hereby incorporated by reference into this application.

### BACKGROUND OF THE INVENTION

1. Field of the Invention

The present invention relates to a test pattern generation apparatus, and pattern generation method, for generating a test pattern to test a program. In particular, the present invention relates to a test pattern generation apparatus, and pattern generation method, for generating a combinational test pattern that can be suitably used to test a program for making the most of existing system resources.

2. Description of the Related Art

In recent years, it has been conducted to shift an existing system to an open environment and construct a new system. In this case, a test for verifying whether the system after the shift operates in the same way as the current system is conducted. In this test, a program test is first made on each of programs included in the system after the shift and then a combinational test with a job taken as the unit is conducted on each job formed of a plurality of programs. The program test conducts operation confirmation of each program, and the combinational test with a job taken as the unit conducts verification on a processing result of each job at a business level.

As a method of the program test, a method of generating a test pattern for checking what sort of operation the current program is conducting by analyzing program information of an existing system and conducting a test by using the program is known. As a conventional technique concerning the generation of the test pattern for testing such a program, a technique described in, for example, JP-A-11-15695 is known. According to the conventional technique, data handling of the program are extracted, execution conditions of the handling are extracted and rearranged, and test patterns are generated.

In the combinational test with a job taken as the unit, the operator of the existing system generates test data, under the existing circumstances. The reason why the operator of the existing system conducts the work for generating the test data is that only the operator well informed on business specifications of the system knows the test pattern of the combinational test with a job taken as the unit (processing to be confirmed and conditions required to execute that processing). And the work of the test data generation needs a very large amount of labor. In addition, since the test pattern is generated according to only business specifications known to the operator, it cannot be verified whether the test pattern is a correct test pattern satisfying all execution conditions of the processing of the jobs to be confirmed.

Even if operation of an individual program is confirmed by the program test, it is necessary to confirm in the subsequently conducted combinational test with a job taken as the unit whether consistency is attained in data exchanged between programs included in the job. The test with a job taken as the unit described above must be executed toward the system running without fail.

### SUMMARY OF THE INVENTION

The above-described conventional technique has a problem that a correct test pattern or test data to be used in the combinational test with a job taken as the unit cannot be generated on the basis of only the business specifications.

In other words, the generation of the test pattern according to the conventional technique is conducted by the operator well informed on the business specifications of the system under the existing circumstances as described above. Even if a person in charge is well informed on the system and well versed in the business, however, there is a limit in the generation of the test pattern. The reason is that there is a problem described below besides simply the generation of the test pattern is personal resulting in insufficiency.

In other words, the data format handled in the existing system is different in many cases from the data format handled after the shift to the open environment. Even if respective programs can be shifted so as to operate normally, the following problem occurs in the case where a plurality of programs are executed consecutively: a value that cannot be neglected is caused as an error, because of a conversion error brought about when the data format is converted from the existing system to the open environment, after a plurality of programs are executed consecutively in the open environment (in other words, in a result of job processing). Even if it looks as if the system shift has been completed in respective program units, therefore, as a matter of fact an erroneous result is output as a job (business processing serving as one clump) although the system operates without errors.

Until now as well, the system operator has generated the test pattern of the job in order to exclude such erroneous results. However, the test pattern that can be supposed by the operator becomes a test pattern based on actual business. Because it is considered to be sufficient if a job pattern actually executed by using the existing system can be executed correctly in the environment after the shift as well.

However, there is no assurance that the existing business is processed in the same pattern as that used until then, in the environment after the shift. As the enterprise grows up and the business is improved, it is possible that new processing is conducted in the environment after the shift. The new processing is based on reformative conception in many cases, and the new processing cannot be covered by the test pattern in the supposed range in some cases. From the viewpoint of data handling, therefore, generation of a test pattern having a possibility of being executed, for processing of a job formed of a plurality of programs becomes an important subject in the system after the shift. In addition, as for a combination of jobs for executing a business formed of a plurality of jobs as well, generation of a combinational pattern of jobs that are outside the supposed range in the business conducted up to then, but that have a possibility of being executed on the system becomes an important subject.

In view of the points described above, therefore, an object of the present invention is to provide a combinational test pattern generation apparatus and a combinational test pattern generation method for generating test patterns that make it possible to confirm and assure, when shifting an existing system to another system environment, that a business obtained by combining a plurality of jobs each implemented by a plurality of programs will operate correctly in the system environment after the shift at the present time and in the future.

In accordance with the present invention, the object is achieved by a test pattern generation apparatus for generating combinational test patterns to be used to test programs for making the most of existing system resources, wherein a combinational test confirmation extraction unit, a test pattern generation unit, a data handling retrieval unit, and a combinational test pattern generation unit are formed in an information processing apparatus; with respect to a job formed of a plurality of programs, the combinational test confirmation extraction unit extracts processing coinciding with input combinational test confirmation processing and execution conditions for executing the processing from a test pattern list used to conduct a program test on programs forming the job; the test pattern generation unit generates a test pattern list in which each of the extracted processing and the execution conditions is provided with a test pattern ID; if processing for handling a data item included in a condition part of the test pattern list exists in a program test pattern list and the processing is data handling satisfying an execution condition of the test pattern list generated by the test pattern generation unit, then the data handling retrieval unit extracts the processing; and the combinational test pattern generation unit arranges execution condition parts of the test pattern list on the basis of test pattern IDs in the test pattern list and generates a test pattern list for a combinational test.

According to the present invention having the configuration described above, all test patterns satisfying the execution conditions of processing that needs confirmation in the combinational test pattern with a job taken as the unit can be automatically generated from program test patterns. Furthermore, according to the present invention, a correct test pattern satisfying all execution conditions of the processing of the job can be generated considering what influence data handling conducted in one of programs forming the job exerts upon what processing in what program in the same job. It becomes possible for a person who does not know business specifications of a system to conduct test data generation assistance and the test data generation work which has been limited only to the operator.

According to the present invention, a combinational test pattern with a job taken as the unit can be generated automatically from program test patterns and it becomes possible to reduce the labor and cost required to generate the combinational test pattern with a job taken as the unit. In addition, it becomes possible to conduct high quality tests without omission.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a functional configuration of a test pattern generation apparatus according to an embodiment of the present invention;

FIG. 2 is a block diagram showing a hardware configuration of a test pattern generation apparatus according to an embodiment of the present invention;

FIG. 3 is a flow chart for explaining general processing operation of test pattern generation for a combinational test in an embodiment of the present invention;

FIG. 4A is a diagram for explaining analysis information of a job taken up in an embodiment of the present invention and programs included in the job;

FIG. 4B is a diagram for explaining outlines of a job taken up in an embodiment of the present invention and programs included in the job;

FIG. 5 is a diagram showing an example of programs included in a job;

FIG. 6A is a diagram showing an example of a test pattern list of a program test for a program PGM1;

FIG. 6B is a diagram showing an example of a test pattern list of a program test for a program PGM2;

FIG. 6C is a diagram showing an example of a test pattern list of a program test for a program PGM3;

FIG. 7 is a diagram showing an example of a combinational test confirmation item list of a job;

FIG. 8 is a diagram showing an example of a test pattern list with processing “WRITE INSATU RECa” in the program PGM1 provided with a test pattern ID;

FIG. 9A is a diagram showing an example of a test pattern list with processing “COMPUTE SHOHIN-KIN=SHOHIN-TANKA×SHOHIN-SU×1.05” in the program PGM2 provided with a test pattern ID;

FIG. 9B is a diagram showing an example of a test pattern list with processing “COMPUTE SHOHIN-KIN=SHOHIN-TANKA×SHOHIN-SU” in the program PGM2 provided with a test pattern ID;

FIG. 10 is a diagram showing an example of a test pattern list with processing “COMPUTE SHOHIN-KIN=SHOHIN-TANKA×SHOHIN-SU×1.05” and processing “COMPUTE SHOHIN-KIN=SHOHIN-TANKA×SHOHIN-SU” in the program PGM2 provided with a test pattern ID;

FIG. 11A is a diagram showing an example of a test pattern list with processing “SHOHIN-TANKA=A-TANKA” in the program PGM3 provided with a test pattern ID;

FIG. 11B is a diagram showing an example of a test pattern list with processing “SHOHIN-TANKA=B-TANKA” in the program PGM3 provided with a test pattern ID;

FIG. 12 is a diagram showing an example of a test pattern list with processing “SHOHIN-TANKA=A-TANKA” and “SHOHIN-TANKA=B-TANKA” in the program PGM3 provided with a test pattern ID;

FIG. 13 is a diagram for explaining test pattern variations; and

FIG. 14 is a diagram showing an example of a test pattern list for a combinational test for confirming processing “WRITE INSATU-RECa” with a job taken as the unit.

### DESCRIPTION OF THE EMBODIMENTS

Hereafter, embodiments of a test pattern generation apparatus and a test pattern generation method according to the present invention will be described with reference to the drawings.

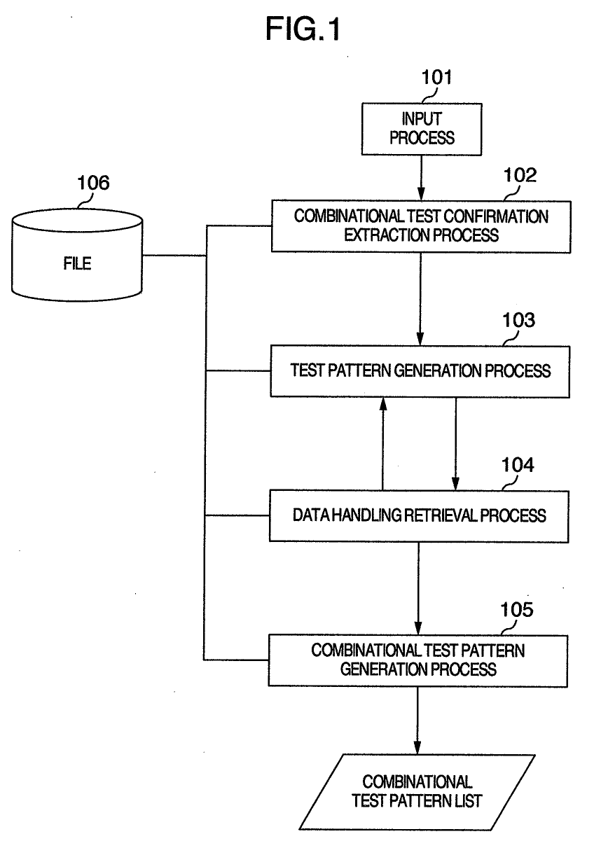

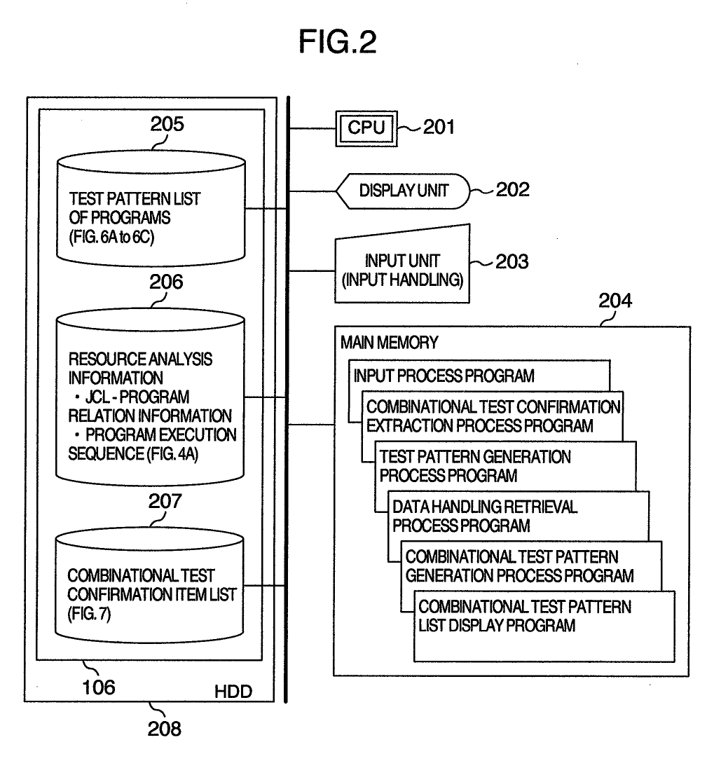

FIG. 1 is a block diagram showing a functional configuration of a test pattern generation apparatus according to an embodiment of the present invention. FIG. 2 is a block diagram showing a hardware configuration of a test pattern generation apparatus according to an embodiment of the present invention.

First, processing functions of the present invention and their operations will be described with reference to FIG. 1. The function of the test pattern generation apparatus according to an embodiment of the present invention includes function parts: an input process 101, a combinational test confirmation extraction process 102, a test pattern generation process 103, a data handling retrieval process 104 and a combinational test pattern generation process 105.

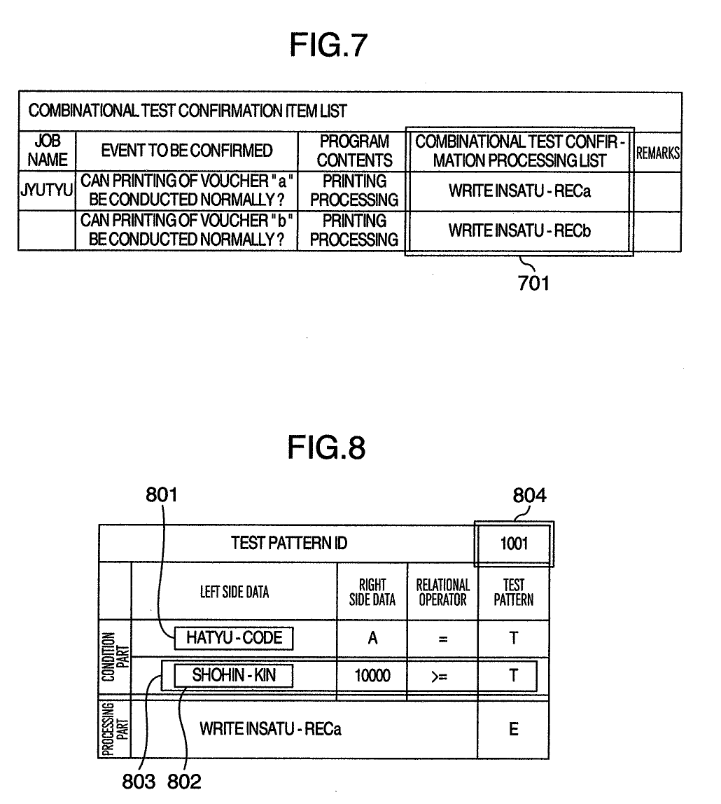

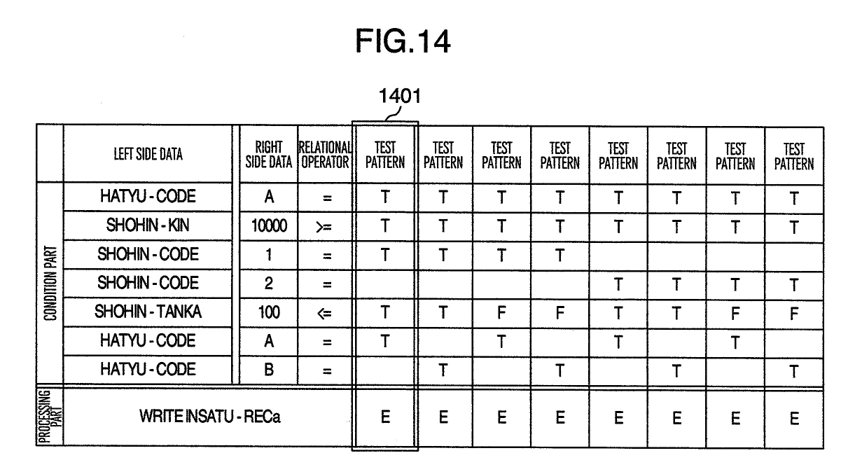

In the test pattern generation apparatus shown in FIG. 1, the input process 101 takes in combinational test confirmation processing 701 input by a worker and described with reference to FIG. 7 later. The combinational test confirmation extraction process 102 retrieves and extracts processing that coincides with combinational test confirmation processing input by the input process 101 from program test patterns 205 stored as a file 106 and described with reference to FIG. 2 later. The test pattern generation process 103 extracts execution conditions of processing extracted by the combinational test confirmation process 102 or the data handling retrieval process 104 from a program test pattern list to which the processing belongs, rearranges the execution conditions, generates one variation of an execution condition for the processing as one test pattern, provides the test pattern with a test pattern ID, and generates a test pattern list described with reference to FIGS. 8, 10 and 12 later. The data handling retrieval process 104 retrieves processing for handling a data item in a condition part of the test pattern list generated by the test pattern generation process 103 from the program test patterns 205, checks whether the retrieved processing is data handling satisfying the condition of the test pattern list generated by the test pattern generation process 103, and extracts the processing if the condition is satisfied. The combinational test pattern generation process 105 generates test pattern variations of a combinational test on the basis of the test pattern IDs, and generates a combinational test pattern list described with reference to FIG. 14 later. This list is displayed to the worker as a combinational test pattern list of a combinational test with a job taken as the unit.

A hardware configuration of the test pattern generation apparatus according to an embodiment of the present invention will now be described with reference to FIG. 2.

The test pattern generation apparatus according to the embodiment of the present invention is formed in an information processing apparatus represented by a well-known PC. The test pattern generation apparatus according to the embodiment includes a CPU 201, a display unit 202, an input unit 203 such as a keyboard and a mouse, a main memory 204, and a storage 208 such as a hard disk device.

The CPU 201 controls execution of a processing procedure in the embodiment of the present invention. The display unit 202 displays information and an execution result of a program to a worker who conducts handling. The input unit 203 is used by the worker to input an instruction. Programs that construct respective function units shown in FIG. 1 when executed by the CPU are stored in the main memory 204. In other words, the input process 101 is constructed by executing an input process program. The combinational test confirmation extraction process 102 is constructed by executing a combinational test confirmation extraction process program. The test pattern generation process 103 is constructed by executing a test pattern generation process program. The data handling retrieval process 104 is constructed by executing a data handling retrieval process program. The combinational test pattern generation process 105 is constructed by executing a combinational test pattern generation process program. A combinational test pattern list display program conducts processing for displaying a test pattern list for a combinational test with a job taken as the unit generated by the combinational test pattern generation process 105, on the display unit 202.

By the way, these programs are previously stored in the storage 208, loaded into the main memory 204 from the storage 208 directly or via a communication line which is not illustrated, and executed by the CPU 201 under an OS which is not illustrated.

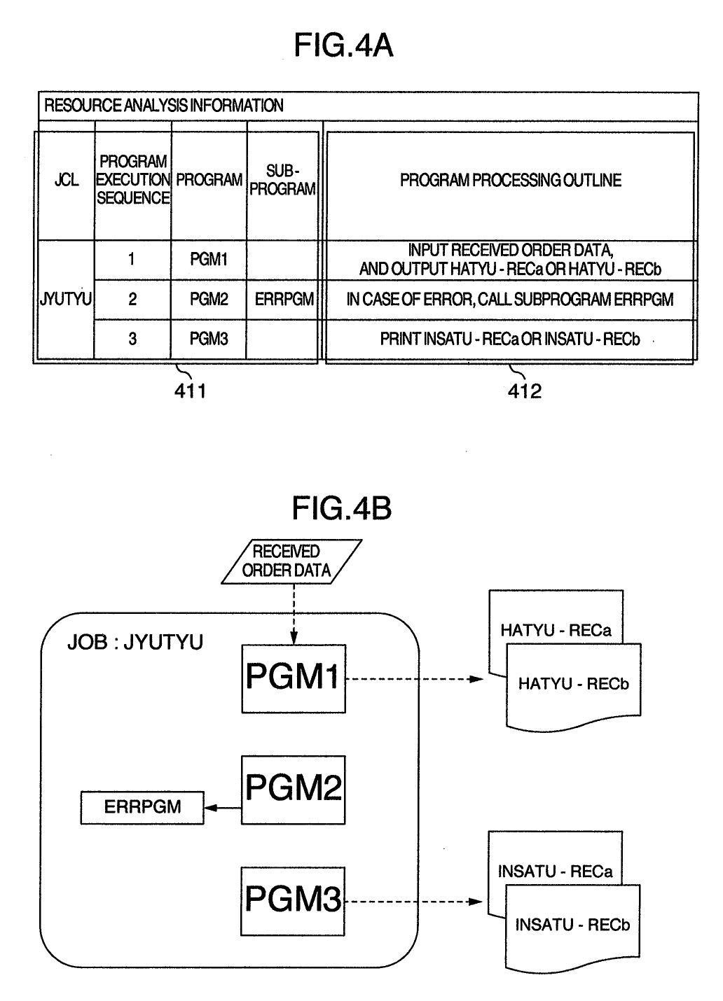

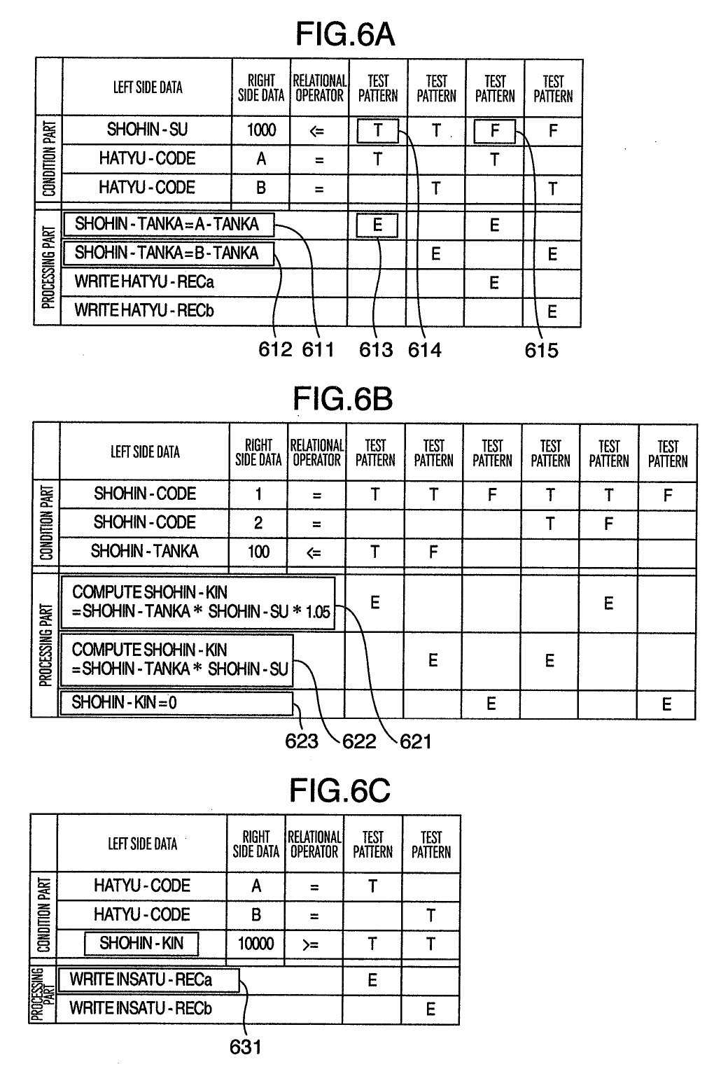

Files 106 used in the present invention are previously stored in the storage 208. As the files 106, a file 205 of “test pattern lists of programs,” a file 206 of “resource analysis information,” and a file 207 of “combinational test confirmation item list” are provided. A test pattern list of programs forming a job to be tested (described with reference to FIGS. 6A to 6C later) is previously stored in the file 205 of “test pattern lists of programs.” JCL-program relation information (described with reference to FIG. 4A later) obtained by analyzing resources such as programs to be tested and JCLs is stored in the file 206 of “resource analysis information.” A list of processing items to be confirmed about jobs to be subjected to a combinational test (described with reference to FIG. 7 later) is stored in the file 207 of “combinational test confirmation item list.”

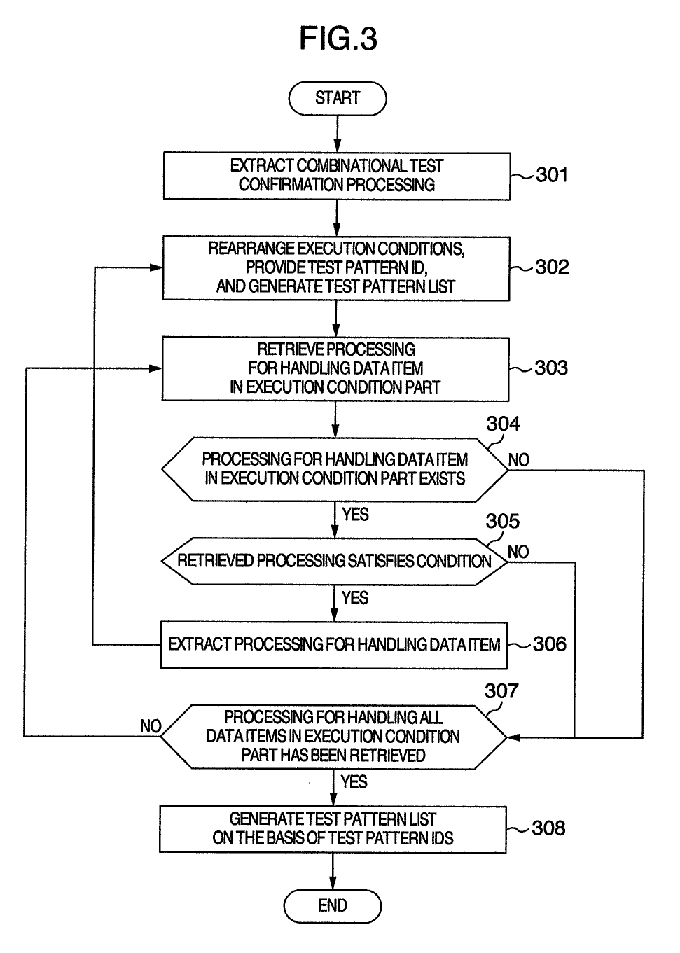

FIG. 3 is a flow chart for explaining general processing operation of test pattern generation for a combinational test in the embodiment of the present invention. The flow chart will now be described.

(1) First, the combinational test confirmation extraction process 102 extracts processing that coincides with combinational test confirmation processing input by the worker, from the file 205 of “test pattern lists of programs” (step 301).

(2) Subsequently, the test pattern generation process 103 extracts execution conditions of processing extracted by the processing conducted at the step 301 or processing conducted at step 305 described later from the file 205 of the program test pattern list to which the processing belongs, rearranges the execution conditions, generates one variation of an execution condition for the processing as one test pattern, provides the test pattern with a test pattern ID, and generates a test pattern list for the processing extracted by the processing conducted at the step 301 or the step 305 (step 302).

(3) And the data handling retrieval process 104 conducts retrieval to check whether processing for handling a data item contained in a condition part (hereafter referred to as execution condition part as well) of the test pattern list generated by the processing at the step 302 exists in processing of the file 205 of “test pattern lists of programs” (step 303).

(4) A decision is made whether the processing retrieved by the processing conducted at the step 303 exists. If it exists, the data handling retrieval process 104 checks whether the processing is data handling satisfying the condition of the test pattern list generated by the test pattern generation process 103 (steps 304 and 305).

(5) If it is judged by the check at the step 305 that the processing retrieved by the processing at the step 303 is data handling satisfying the condition of the test pattern list generated by the test pattern generation process 103, the data handling retrieval process 104 extracts the processing, returns to the processing conducted at the step 302 and subsequent steps, and continues the processing (step 306).

(6) If it is judged by the decision at the step 304 that the processing retrieved at the step 303 does not exist in the processing of the program test pattern, or if it is judged by the decision at the step 305 that the processing retrieved at the step 303 is not data handling satisfying the condition of the test pattern list generated by the test pattern generation process 103, then it is checked whether the work at the step 303 has been conducted for all data items in the execution condition part in the test pattern list generated at the step 302. If the work at the step 303 has been conducted for all data items and items to be subjected to the work, then the data handling retrieval process 104 returns to the processing at the step 303 and subsequent steps, and continues the processing (step 307).

(7) If it is judged by the check at the step 307 that the work at the step 303 has been conducted for all data items in the execution condition parts in the test pattern lists generated at the step 302, the combinational test pattern generation process 105 arranges condition parts in the test pattern lists generated by the processing at the step 302 on the basis of test pattern IDs in the test pattern lists, excludes conditions containing data items to be subjected to data handling processing extracted by the processing at the step 306, from the condition parts, and generates a test pattern list of the combinational test (described with reference to FIG. 14 later). A table generated here becomes a final test pattern list of the combinational test (step 308).

FIG. 4A is a diagram for explaining analysis information of a job taken up in the embodiment of the present invention and programs included in the job. FIG. 4B is a diagram for explaining outlines of a job taken up in the embodiment of the present invention and programs included in the job. They will now be described.

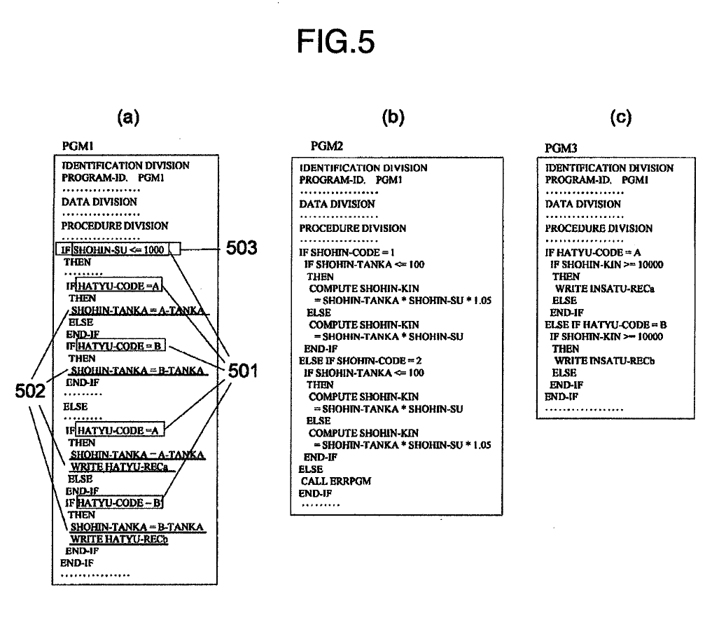

An example of analysis information of a job and programs included in the job shown in FIG. 4A is “resource analysis information” stored in the file 206 shown in FIG. 2. The “resource analysis information” is obtained by analyzing system resources such as programs (described with reference to FIG. 5 later) and JCLs, and representing information, such as JCL-program relations and program execution sequence 411 and processing outlines of respective programs 412, in a table as shown in FIG. 4A. An example shown here indicates that a job JYUTYU (where “JYUTYU” stands for order receiving) includes three programs PGM1, PGM2 and PGM3 and the programs PGM1, PGM2 and PGM3 are executed in this sequence and indicates processing outlines of the programs PGM1, PGM2 and PGM3.

The outlines of a job and programs included in the job shown in FIG. 4B indicate outlines of a job and programs included in the job generated on the basis of “resource analysis information” shown in FIG. 4A. As a matter of fact, the apparatus in the embodiment of the present invention stores “resource analysis information” in a table in a table form as shown in FIG. 4A and reads that information directly. Here, however, the outline is shown as an outline as shown in FIG. 4B to explain a detailed case described later.

FIG. 5 is a diagram showing an example of programs included in a job. A program PGM1 shown in FIG. 5(a) is a program executed first when the job JYUTYU is started. The program PGM1 describes processing for inputting received order data and outputting HATYU-RECa or HATYU-RECb (where “HATYU” stands for order giving). A program PGM2 shown in FIG. 5(b) is a program executed subsequently. The program PGM2 describes processing for calling a subprogram ERRPGM in the case of an error. A program PGM3 shown in FIG. 5(c) is a program executed at the end of the job JYUTYU. The program PGM3 describes processing for printing INSATU-RECa or INSATU-RECb (where “INSATU” stands for printing). In the drawings, “*” represents the multiplication operator.

FIG. 6A is a diagram showing an example of a test pattern list of a program test for the program PGM1. FIG. 6B is a diagram showing an example of a test pattern list of a program test for the program PGM2. FIG. 6C is a diagram showing an example of a test pattern list of a program test for the program PGM3. Each of the test pattern lists shown in FIGS. 6A to 6C is automatically generated from the object program by using existing techniques such as “program test pattern automatic generation system” described in JP-A-11-15695, and stored in the file 205 shown in FIG. 2. Each of these program test pattern lists is obtained by arranging all condition patterns to be satisfied to execute each of all processing concerning data to be tested by taking a program as the unit, into a list as a condition part.

In these lists, it is indicated by execution state information 613 “E (Execute)” that processing has been executed. It is indicated by information 614 “T (Truth)” that a condition is satisfied. It is indicated by information 615 “F (False)” that a condition is not satisfied.

By taking a program test pattern of the program PGM1 shown in FIG. 6A as an example, its meaning will now be described. The program test pattern shown in FIG. 6A is generated from the program PGM1 shown in FIG. 5(a). A part 501 shown in FIG. 5(a) is a condition part for judging the data value and determining processing to be executed subsequently. A part 502 is a processing part executed in the program. The condition part 501 is represented as a “condition part” of a program test pattern shown in FIG. 6A. A conditional statement 503 “SHOHIN-SU<=1000” is represented by left side data “SHOHIN-SU”, right side data “1000” and a relational operator “<=” (where “SHOHIN-SU” stands for the number of articles of a commodity). A processing part 502 is represented as a processing part of the program test pattern shown in FIG. 6A. According to contents of the condition part, the corresponding processing part is determined. The same is true of FIG. 6B and FIG. 6C as well.

FIG. 7 is a diagram showing an example of a combinational test confirmation item list of a job. The combinational test confirmation item list shown in FIG. 7 is obtained by arranging processing to be confirmed at the time of the combinational test into a list on the basis of results of customer hearing. The combinational test confirmation item list shown in FIG. 7 is previously stored in the file 207 shown in FIG. 2.

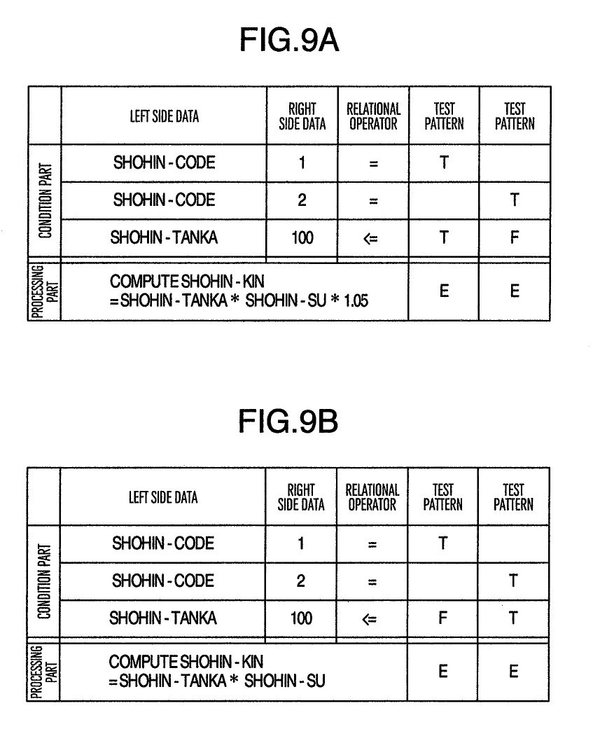

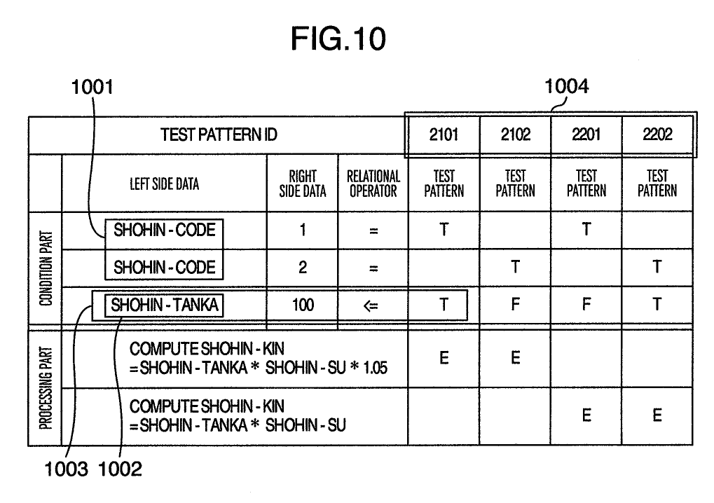

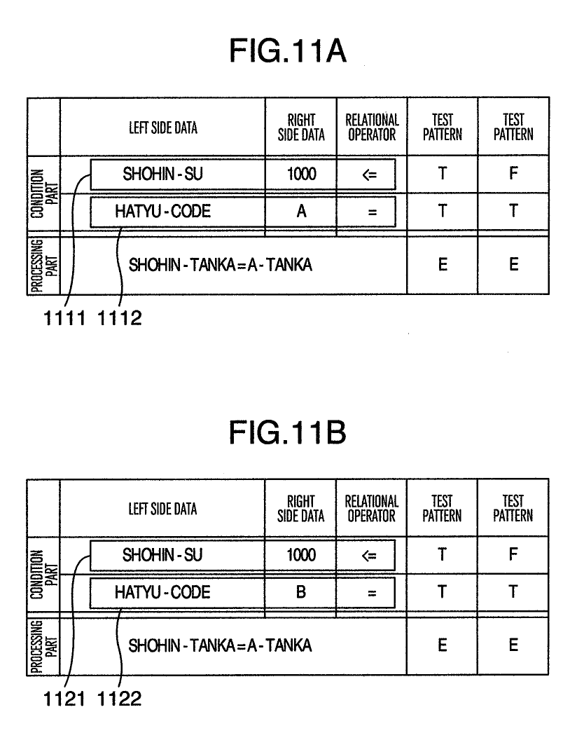

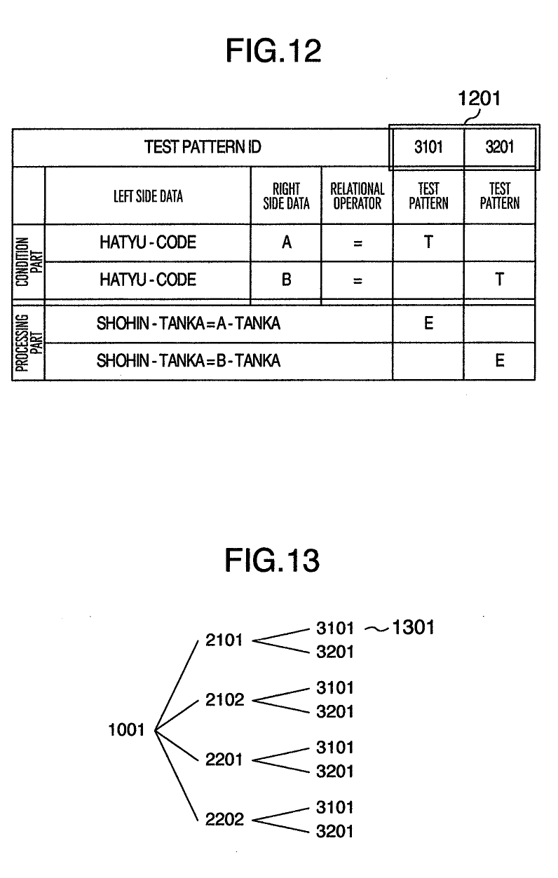

FIG. 8 is a diagram showing an example of a test pattern list with processing “WRITE INSATU RECa” in the program PGM1 provided with a test pattern ID. FIG. 9A is a diagram showing an example of a test pattern list with processing “COMPUTE SHOHIN-KIN=SHOHIN-TANKA×SHOHIN-SU×1.05” in the program PGM2 provided with a test pattern ID. FIG. 9B is a diagram showing an example of a test pattern list with processing “COMPUTE SHOHIN-KIN=SHOHIN-TANKA×SHOHIN-SU” in the program PGM2 provided with a test pattern ID. FIG. 10 is a diagram showing an example of a test pattern list with processing “COMPUTE SHOHIN-KIN=SHOHIN-TANKA×SHOHIN-SU×1.05” and processing “COMPUTE SHOHIN-KIN=SHOHIN-TANKA×SHOHIN-SU” in the program PGM2 provided with a test pattern ID. FIG. 11A is a diagram showing an example of a test pattern list with processing “SHOHIN-TANKA=A-TANKA” in the program PGM3 provided with a test pattern ID. FIG. 11B is a diagram showing an example of a test pattern list with processing “SHOHIN-TANKA=B-TANKA” in the program PGM3 provided with a test pattern ID. FIG. 12 is a diagram showing an example of a test pattern list with processing “SHOHIN-TANKA=A-TANKA” and “SHOHIN-TANKA=B-TANKA” in the program PGM3 provided with a test pattern ID. FIG. 13 is a diagram for explaining test pattern variations. FIG. 14 is a diagram showing an example of a test pattern list of a combinational test for confirming processing “WRITE INSATU-RECa” with a job taken as the unit.

Hereafter, as a concrete example of processing in the embodiment of the present invention, processing of generating a combinational test pattern for confirming whether processing “WRITE INSATU-RECa” in a combinational test confirmation processing list 701 shown in FIG. 7 is conducted normally when conducting a combinational test on the job described with reference to FIG. 4B will be described with reference to FIGS. 6A to 14.

First, outline of the job to be subjected to the combinational test will now be described with reference to FIG. 4B again. A job “JYUTYU” executes processing on input of “received order data” in the order of “PGM1”, “PGM2” and “PGM3”, outputs “INSATSU-RECa” or “INSATSU-RECb”, and finishes. In processing on the way, the PGM1 outputs “HATYU-RECa” or “HATYU-RECb.” If there is an error decision, the PGM2 calls a subprogram “ERRPGM” and conducts processing.

A procedure of the combinational test pattern generation processing will now be described.

First, the worker gives a generation instruction of a test pattern for confirming “WRITE INSATU-RECa” to the test pattern generation apparatus according to the embodiment of the present invention. This instruction is given by the worker who selects processing for generating a test pattern, i.e., “WRITE INSATU-RECa” from the “combinational test confirmation item list” displayed on the display unit 202 shown in FIG. 2 and described with reference to FIG. 7 and inputs an execution instruction from the input unit 203.

Upon receiving this instruction, the combinational test confirmation extraction process 102 in the test pattern generation apparatus retrieves processing that coincides with “WRITE INSATU-RECa” from the test pattern lists of the program test shown in FIGS. 6A to 6C. Processing that coincides with “WRITE INSATU-RECa” is processing 631 described in the processing part in the program test pattern of the PGM3 shown in FIG. 6C, and the processing 631 is extracted.

Subsequently, the test pattern generation process 103 in the test pattern generation apparatus extracts a condition for executing the extracted processing “WRITE INSATU-RECa” in the PGM3 from the condition part of the program test pattern, provides each pattern of execution conditions with a test pattern ID as one test pattern, and generates a test pattern list as shown in FIG. 8.

Subsequently, the data handling retrieval process 104 in the test pattern generation apparatus conducts retrieval to check whether processing for handling “HATYU-CODE” of a data item 801 and “SHOHIN-KIN” of a data item 802 in the condition part of the generated test pattern list shown in FIG. 8 exists in the processing parts of the program test patterns (where “SHOHIN-KIN” stands for a sum of money of a commodity). Processing for handling the data item 801 “HATYU-CODE” does not exist in the processing parts of the program test pattern lists of the PGM1 and PGM2 shown in FIG. 6A and FIG. 6B. Processing for handling the data item 802 “SHOHIN-KIN” exists as processing 621 (“COMPUTE SHOHIN-KIN=SHOHIN-TANKA×SHOHIN-SU×1.05”), processing 622 (“COMPUTE SHOHIN-KIN=SHOHIN-TANKA×SHOHIN-SU”, and processing 623 (“SHOHIN-KIN=0”) in the processing part of the program test patterns of the PGM2 (where “SHOHIN-TANKA” stands for a unit price of the commodity).

By handling conducted by each of these kinds of processing, it is checked whether the data item 802 “SHOHIN-KIN” shown in FIG. 8 is handling satisfying a condition 803 (“SHOHIN-KIN>=10000”). In the processing 621 and 622, it depends upon values of “SHOHIN-TANKA”, “SHOHIN-SU” whether the data item 802 satisfies the condition 803. At this stage, the processing 621 and 622 are extracted as processing having a possibility of satisfying the condition. In the processing 623, 0 is substituted for “SHOHIN-KIN” and a condition 632 is not satisfied. Therefore, extraction of the processing 623 is not conducted.

The test pattern generation process 103 in the test pattern generation apparatus extracts execution conditions of the extracted processing 621 and 622 from the program test pattern, rearranges the execution conditions, and provides the execution condition with test pattern IDs. In other words, the test pattern generation process 103 first extracts only an execution condition of the processing 621 from the condition part of the program PGM2, generates a test pattern list as shown in FIG. 9A, and generates a test pattern list as shown in FIG. 9B for the processing 622 in the same way. Here, it is checked whether condition parts of those test patterns are formed of only conditions indispensable to the execution of the processing. If there is a condition indispensable to the execution of the processing, the condition is excluded. Since the test pattern list of each of the processing 621 and 622 is formed of conditions indispensable to the execution of the processing, there are no conditions to be excluded. Thereafter, the test pattern generation process 103 provides each test pattern variation in the test pattern list of each of the processing 621 and 622 with a test pattern ID, and generates a test pattern list as shown in FIG. 10 collectively.

Thereafter, the data handling retrieval process 104 conducts retrieval to check whether processing for handling a data item 1001 “SHOHIN-CODE” and processing for handling a data item 1002 “SHOHIN-TANKA” in the condition part of the test pattern list shown in FIG. 10 exist in the processing parts of the program test patterns shown in FIGS. 6A to 6C (where “SHOHIN-CODE” stands for “commodity code). The processing for handling the data item 1001 “SHOHIN-CODE” does not exist in the processing part of the program test pattern of the program PGM1. Processing for handling the data item 1002 “SHOHIN-TANKA” exists as processing 611 “SHOHIN -TANKA=A-TANKA” and processing 612 “SHOHIN-TANKA=B-TANKA” in the processing part of the program test pattern of the program PGM1 (where “A-TANKA” stands for A unit price and “B-TANKA” stands for B unit price). It is checked whether the processing 611 and 612 is handling satisfying a condition 1003 “SHOHIN-TANKA<=100” for the data item 1002 “SHOHIN-TANKA.” Whether the processing 611 and 612 satisfy the condition depends upon values of “A-TANKA” and “B-TANKA.” At this stage, the processing 611 and 612 are extracted as processing having a possibility of satisfying the condition.

The test pattern generation process 103 extracts execution conditions of the extracted processing 611 and 612 from the program test pattern, rearranges the execution conditions, and provides the execution conditions with test pattern IDs. In other words, the test pattern generation process 103 first extracts only an execution condition of the processing 611 from the condition part of the program PGM1 and generates a test pattern list shown in FIG. 11A. In the same way, the test pattern generation process 103 generates a test pattern list as shown in FIG. 11B. Here, the test pattern generation process 103 checks whether the condition part of each of those test patterns is formed of only conditions indispensable to the execution of the processing. If a condition that is not indispensable to the execution of the processing exists, the test pattern generation process 103 excludes the condition.

Regardless of whether an execution state of a condition 1111 is “T” or “F” in the test pattern list of the processing 611 shown in FIG. 11A, the processing is executed as long as an execution state of a condition 1112 is “T.” Therefore, it can be judged that the condition 1111 is not indispensable, and the condition 1111 is excluded. Regardless of whether an execution state of a condition 1121 is “T” or “F” in the test pattern list of the processing 621 shown in FIG. 11B as well, the processing is executed in the same way as long as an execution state of a condition 1122 is “T.” Therefore, it can be judged that the condition 1121 is not indispensable, and the condition 1121 is excluded.

With respect to the test pattern lists of the processing 611 and 612 rearranged as described above, the test pattern generation process 103 provides each test pattern variation with a test pattern ID, arranges them, and generates a test pattern list as shown in FIG. 12.

Subsequently, the data handling retrieval process 104 conducts retrieval to check whether processing for handling a data item 1201 “HATYU-CODE” in a condition part of the test pattern list shown in FIG. 12 exists in the processing part of the program test patterns shown in FIGS. 6A to 6C. The processing for handling the data item 1201 does not exist in the program test patterns.

The combinational test pattern generation process 105 generates test pattern variations of a combinational test on the basis of the test pattern IDs provided by the processing heretofore described.

As heretofore described, the test pattern ID provided first of all is a test pattern ID 804 “1001” in the test pattern list shown in FIG. 8. For satisfying its condition, it is necessary to satisfy a condition of any one of test patterns “2101”, “2102”, “2201” and “2202” of a test pattern ID 1004 provided subsequently and shown in FIG. 10. In addition, for satisfying the condition of the test pattern of the test pattern ID 1004, it is necessary to satisfy a condition of any one of test patterns “3101” and “3102” of a test pattern ID 1201 shown in FIG. 12.

In the embodiment of the present invention, the combinational test pattern generation process 105 memorizes the necessity of the test pattern described above, and generates test pattern variations. In FIG. 13, a concrete example of the test pattern variations is shown with test pattern IDs.

The combinational test pattern generation process 105 arranges respective condition parts of the test pattern lists provided with test pattern IDs shown in FIGS. 8, 10 and 12 in accordance with the test pattern variations shown in FIG. 13, and generates a test pattern list for confirming the processing “WRITE INSATU-RECa” with a job taken as the unit as shown in FIG. 14.

In the case of a test pattern variation 1301 shown in FIG. 13, all of the conditions of the test pattern ID “1001”, conditions of the test pattern ID “2101” and conditions of the test pattern ID “3101” are extracted and arranged. As a result, a condition part of a test pattern 1401 shown in FIG. 14 is generated. In this case, the combinational test confirmation processing 701 is described in the processing part. Similar processing is conducted on other variations as well, and results are arranged as a test pattern list.

A test pattern list for the combinational test generated as described above is shown in FIG. 14. In the embodiment of the present invention, the combinational test pattern list is displayed to the worker. The worker who watches the display recognizes that test data satisfying the condition part of the combinational test pattern list should be generated. In the example shown in FIG. 14, there are eight variations in the condition part of the combinational test pattern list. Therefore, the worker generates eight kinds of test data. For example, it is recognized that test data satisfying a test pattern 1401 which is one of the eight kinds satisfies “HATYU-CODE=ÂSHOHIN-KIN<=1000̂SHOHIN-CODE=1̂SHOHIN-TANKA<=100̂HATYU-CODE=A” from the condition part. (“̂” means an AND operator.) As for the remaining test patterns, it becomes possible in the same way for the worker to read a value to be assumed by test data from the condition part and generate test data for confirming execution of the processing “WRITE INSATU-RECa” without omission.

It is possible to form each processing in the embodiment of the present invention by using programs and cause a CPU to execute the programs. Those programs can be stored in a recording medium such as a FD, a CDROM or a DVD and provided. Or the programs can be provided as digital information via a network.

The present invention can be utilized in assisting a process for generating test data, when the worker conducts a test with a job taken as the unit, on the basis of the test pattern list of the combinational test generated by the present invention.

It should be further understood by those skilled in the art that the foregoing description has been made on embodiments of the invention and that various changes and modifications may be made in the invention without departing from the spirit of the invention and the scope of the appended claims.

1. A test pattern generation apparatus for generating combinational test patterns to be used to test programs by using existing system resources, wherein
combinational test confirmation extraction means, test pattern generation means, data handling retrieval means, and combinational test pattern generation means are formed in an information processing apparatus,
with respect to a job formed of a plurality of programs, the combinational test confirmation extraction means extracts processing that coincides with input combinational test confirmation processing and execution conditions for executing the processing, from program test pattern lists used to conduct a program test on programs included in the job,
the test pattern generation means generates test pattern lists, in which each of the extracted processing and the execution conditions is provided with a test pattern ID,
if processing for handling a data item included in condition parts of the test pattern lists exists in the program test pattern lists and the processing is data handling that satisfies an execution condition in the test pattern lists generated by the test pattern generation means, then the data handling retrieval means extracts the processing, and
the combinational test pattern generation means arranges execution condition parts of the test pattern lists on the basis of test pattern IDs in the test pattern lists and generates a test pattern list of a combinational test.

2. The test pattern generation apparatus according to claim 1, wherein the combinational test pattern generation means generates a test pattern list of a combinational test with a job taken as unit satisfying all execution conditions of processing of a job.

3. The test pattern generation apparatus according to claim 1, wherein the combinational test pattern generation means generates a test pattern list of a combinational test by excluding execution conditions including data items to be subjected to the extracted data handling processing, from an execution condition part obtained by arranging the test pattern lists.

4. The test pattern generation apparatus according to claim 1, wherein when extracting execution conditions for executing processing to be confirmed with a job as unit, from the test pattern lists, the combinational test pattern generation means extracts an execution condition indispensable to execution of the processing and generates a test pattern list of a combinational test having the extracted execution condition as a condition part of a combinational test with a job taken as unit.

5. The test pattern generation apparatus according to claim 1, wherein test patterns of the combinational test generated by the combinational test pattern generation means are formed of combinations of processing to be confirmed in a test with a job taken as unit and execution conditions for the processing.

6. A test pattern generation method used by an information processing apparatus to generate combinational test patterns to be used to test programs by using existing system resources, the test pattern generation method comprising:
a combinational test confirmation extraction step of, with respect to a job formed of a plurality of programs, extracting processing that coincides with input combinational test confirmation processing and execution conditions for executing the processing, from program test pattern lists used to conduct a program test on programs included in the job;
a test pattern generation step of generating test pattern lists in which each of the extracted processing and the execution conditions is provided with a test pattern ID;
a data handling retrieval step of, responsive to processing for handling a data item included in condition parts of the test pattern lists existing in the program test pattern lists and the processing being data handling that satisfies an execution condition of the test pattern lists generated at the test pattern generation step, extracting the processing; and
a combinational test pattern generation step of arranging execution condition parts of the test pattern lists on the basis of test pattern IDs in the test pattern lists and generating a test pattern list of a combinational test.

7. The test pattern generation method according to claim 6, wherein the combinational test pattern generation step involves generating a test pattern list of a combinational test with a job taken as unit satisfying all execution conditions of processing of a job.

8. The test pattern generation method according to claim 6, wherein the combinational test pattern generation step involves generating a test pattern list of a combinational test by excluding execution conditions including data items to be subjected to the extracted data handling processing, from an execution condition part obtained by arranging the test pattern lists.

9. The test pattern generation method according to claim 6, wherein when extracting execution conditions for executing processing to be confirmed with a job as unit from the test pattern lists, the combinational test pattern generation step involves extracting an execution condition indispensable to execution of the processing and generating a test pattern list of a combinational test having the extracted execution condition as a condition part of a combinational test with a job taken as unit.

10. The test pattern generation method according to claim 6, wherein test patterns of the combinational test generated at the combinational test pattern generation step are formed of combinations of processing to be confirmed in a test with a job taken as unit and execution conditions for the processing.
